(19) United States
(12) Patent Application Publication
(10) Pub. No.: US 2017/0167902 A1
(43) Pub. Date: Jun. 15, 2017

(54) Arrangement for Measuring the Quantity of Protective Gas

(71) Applicant: J. Thielmann Gesellschaft fuer Automatisierungstechnik mbH, Haiger-Rodenbach (DE)

(72) Inventors: Hans-Joachim THIELMANN, Haiger (DE); Johannes THIELMANN, Herborn (DE)

(21) Appl. No.: 15/375,549

(22) Filed: Dec. 12, 2016

(30) Foreign Application Priority Data
Dec. 13, 2015 (DE) 10 2015 121 679.5

(51) Int. Cl. G01F 1/28; B23K 9/32; B23K 37/00

(52) U.S. Cl. CPC G01F 1/28; B23K 37/00; B23K 9/328

(57) ABSTRACT

An arrangement for measuring the quantity of protective gas for robot-controlled importable welding torches with a protective gas nozzle in the measuring arrangement, characterized in that the measuring arrangement includes a spring-mounted receiving cup in the direction of the insertion of a welding torch in and/or with the measuring arrangement, with a sealing ring surrounding the welding torch on its outer circumference.

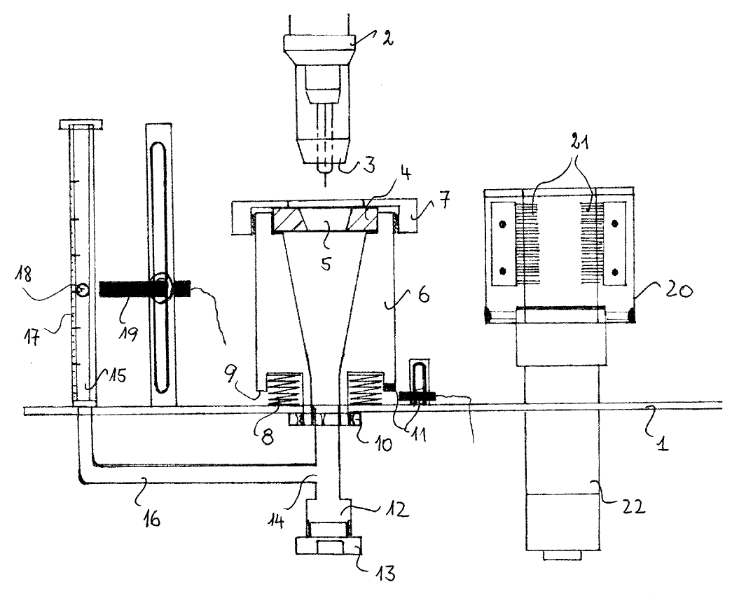

The invention relates to an arrangement for measuring the quantity of protective gas with the features of the generic concept of claim 1.

From the publication DE 103 36 651 A1, a protective gas welding system which contains a device for the measurement of the flow rate of the protective gas in the protective gas nozzle of a robot-controlled welding torch is known. The device is located in the working area of the welding robot, which cyclically inserts the welding torch into the intake of the flow meter in a computer-controlled manner.

The gas nozzle of the welding torch is usually equipped with a conically tapered front section. The intake of the flow meter is correspondingly equipped with a conically open funnel. On the basis of the existing dependence between the gas nozzle and the funnel-shaped intake of the flow meter, the flow measurement system and the welding head are to be adjusted to each other in each individual case.

An electronic sensor for the measurement of the flow rate of protective gas is connected to the flow meter.

From the publication DE 10 2004 036 428 A1, an electromagnetically measuring variable area flow meter with an electrical output signal is known.

The measurement of the welding gas quantity is essential for maintenance of the quality of a weld seam generated. With too little protective gas there is the danger of having a defective weld seam through oxygen inclusions. A protective gas flow rate which is too high is expensive on the one hand and can also lead to defective weld seams due to the irregular collection of oxygen.

The airtight system in the gas nozzle of the welding torch in the funnel-shaped intake of the flow meter is essential for an exact flow rate measurement. In order to guarantee this, pressure is applied to the welding torch, which can lead to deformations in the robotic arm support, or to the response of an automatic shutdown of the torch which is mounted between the robotic arm and the welding torch.

During an ongoing welding operation, welding spatters from the welding process can lead to contaminations on the welding torch, especially in the gas nozzle and on its outer surface. Despite the pressure applied, the adhering dirt particles lead to leakages between the funnel-shaped intake of the flow meter and the welding torch, so that the protective gas flowing into the flow meter also collects air from the environment. The measurement of the flow rate becomes inaccurate and can lead to complaints regarding the quality of the weld seam.

From the publication AT 504 964 A1, a device and a method for the measurement of the protective gas is known. The measurement device contains at least one sensor for the measurement of a gas property of the protective gas. The sensor is positioned in the external measurement device at a distance from the torch which corresponds to the distance of the torch from the workpiece during a welding process.

The object of the invention is therefore to create an arrangement for measuring the quantity of protective gas which guarantees an airtight intake into the flow rate measuring arrangement even in the event of moderate contamination of the gas nozzle of the welding torch, which is independent from the shape of the gas nozzle of the welding torch or easily adjustable to the changing shapes of the gas nozzle of the welding torch. The measuring arrangement should additionally prevent the response of an automatic shutdown of the torch which is mounted between the robotic arm and the welding torch, as well as damage to the welding torch by bending, and should be deployable in automotive manufacturing with painting after the welding procedure.

This problem is solved according to this invention by means of a measuring arrangement with the distinguishing features of claim 1. Advantageous further developments arise from the features of the subclaims.

A significant feature of the arrangement according to this invention is a spring-mounted receiving cup with a sealing ring in its intake opening. The spring-mounting of the receiving cup can occur separately within the measuring arrangement and/or together with the measuring arrangement.

The spring deflection of the receiving cup or of the measuring arrangement can be configurable in order to make it possible to adjust the bending strength of the welding torch to the pressure applied when inserting the gas nozzle of the welding torch onto the receiving cup. The configured spring deflection can be visually observed, whereby the configuration is facilitated by a machine setter and a simple control of the functionality is possible. At least one distance sensor can also be associated with the spring deflection, through which it is possible to automatically control whether the gas nozzle of the welding torch under pressure is in the sealing ring of the receiving cup. Naturally, several distance sensors can also be provided in order to be able to automatically monitor the position of the receiving cup within or without the desired spring deflection.

A pressure sensor with overload protection can be assigned to the springs in order to be able to prevent deformations of the welding torch independently from a safeguard mounted in the robotic arm.

The springs can exhibit a slight clearance laterally to the insertion direction of the gas nozzle of the welding torch in order to be able to absorb small tilting motions when inserting the gas nozzle of the welding torch deviating from the axial direction of the receiving cup.

The sealing ring can interchangeably be kept in the insertion opening of the receiving cup for various gas nozzles. This enables simple interchangeability in case of wear on the one hand. Its insertion opening can also easily be adjusted to the molding of the gas nozzle of a welding torch. On the basis of the counter-pressure existing as a result of the spring-mounting of the receiving cup, a circular enclosure of the gas nozzle of the welding torch is generally sufficient for flow-safe sealing. This effect can further be enhanced by a suitably temperature-resistant flexible material with 75+/−10% Shore hardness. For the use of the measuring arrangement in the automotive industry, the sealing ring is manufactured in an especially advantageous manner from a non-gas-emitting material, in particular without silicone.

The flow meter is appropriately connected to the receiving cup via a flexible cable. The flow meter advantageously contains a transparent tube in which a ball is lifted, floating, by the flow pressure. The tube, necessarily open at the top, is appropriately secured with a cover against the incursion of dirt.

A vertically adjustable sensor which detects the height of the ball can be arranged on the tube. The flow pressure and the sensor are configured to the necessary flow rate for the welding procedure. The configuration can be observed visually. Two or more sensors can be naturally also assigned to the tube in order to be able to indicate a pressure range or various pressures.

Below the port for the flow meter, a reservoir for capturing dirt particles is appropriately provided, which can be emptied after removal of the drain screw.

In the event of heavier contamination of the gas nozzle of the welding torch, it is advantageous to assign to the measuring arrangement a separate cleaning pot, in which elongated, vertical brushes are preferably arranged in a rotatable manner, in the center of which the welding torch can be robotically inserted before likewise robotic insertion into the receiving cup.

Due to the length of the brushes, which are appropriately arranged vertically or at a corresponding angle, larger surfaces of the slightly conical or cylindrical outer mantel of a welding head can be cleaned.

An embodiment of the measuring arrangement according to this invention is schematically illustrated in the drawing and is described in more detail below.

### BRIEF DESCRIPTION OF THE DRAWING

The arrangement for measuring the quantity of protective gas illustrated in the drawing shows a welding torch 2 in the area of a mounting plate 1 of a casing (not shown), which is moved in a controlled manner via a robotic arm, also not shown. The welding torch 2 includes a gas nozzle 3 for the outflow of protective gas.

### DETAILED DESCRIPTION OF THE PREFERRED EMBODIMENTS

The casing (not shown) is appropriately designed such that connecting parts protruding from the side of the measuring arrangement are secured against breakages owing to impact, but are accessible and observable via an open area.

For measurement of the protective gas quantity, the welding torch 2 is inserted into the sealing ring 4, wherein the conical tip of the gas nozzle 3 of the welding torch 2 is pressed into the adjusted opening 5 in the sealing ring 4.

The sealing ring 4 is kept in a receiving cup 6 using a ring nut 7. After removing the ring nut 7, the sealing ring 4 can be removed from its support in the receiving cup 6 and replaced. The rim of opening 5 can be conically refracted or cylindrical. It can also be different on the bottom and on the top, so that dual use is possible for various welding torch shapes simply by turning it in its support.

Since the gas nozzle 3 of the welding torch 2 becomes hot during the welding procedure and the measurement of the protective gas quantity is cyclically repeated immediately after a welding procedure, the sealing ring 4 must be made from a temperature-resistant, preferably non-gaseous, in particular silicone-free material. For airtight installation in the opening 5, even in case of moderate external contamination of the gas nozzle 3, it is advantageous for the material of the sealing ring 4 to additionally have a certain degree of flexibility. A 75+/−10% Shore hardness has proven to be advantageous.

For the secure airtight installation of the gas nozzle 3 in the opening 5 of the sealing ring 4, the welding torch 2 is inserted under pressure into the opening 5.

The receiving cup 6 is mounted via a spiral spring 8 onto the mounting plate 1 and thus generates a counter-pressure when inserting the welding torch 2 in the opening 5. The force of the counter-pressure can be visually observed via the spring deflection between the bottom rim 9 of the receiving cup 6 and the mounting plate 1. The preloading of the spiral spring 8 can be adjusted via a nut 10 below the mounting plate 1.

A pressure sensor (not shown) with overload protection can be inserted into the mounting of the spiral spring 8. Alongside visual observation of the spring deflection, a distance sensor 11 can also be arranged at the bottom rim 9 of the receiving cup 6. Instead of the spiral spring 8 shown, other spring elements such as disk springs or shock absorbers can also be provided. To protect the spring elements against contamination, these can be enclosed by a sleeve.

The configurable mounting of the receiving cup 6 in the mounting plate 1 also allows slight tilting motions of the receiving cup 6, which can offset a not precisely vertical insertion of the welding torch 2 into the opening 5. Inserting the welding torch 2 under pressure leads to friction between the outer circumference surface of the gas nozzle 3 and the delimitation of the opening 5. The outer circumference can be abraded by dirt particles here. When the welding torch 2 is placed on the sealing ring 4, an impact can occur through which the adhering dirt particles can be released inside the gas nozzle 3. The dirt particles released fall into the receiving cup 6 and are captured by a reservoir 12. To prevent dirt particles from being deposited above the reservoir 12, the inner wall surface of the receiving cup 6 leads to the reservoir 12 with a tapered design. The reservoir 12 can be emptied via a drain screw 13.

Above the reservoir 12, there is an output 14 on the receiving cup 6 for the connection of a measuring tube 15 measuring the flowing quantity of protective gas. The measuring tube 15 is also arranged on the mounting plate 1 and is connected via a flexible cable 16, in particular made from a silicone-free material, to the output on the receiving cup 6, in order to be able to balance out variations as a result of the spring deflection of the receiving cup 6. With spring-mounting of the mounting plate 1, a rigid cable 16 can also be provided.

The measuring tube 15 is transparent and is equipped with a scale 17. With the flow of the protective gas, a ball 18 is visibly lifted in the measuring tube 15. The height of the ball 18 according to the target flow rate of the protective gas can be visually indicated via an adjustable marking 19. An indicator detecting the ball 18 which emits a signal when the ball 18 passes through it can also be assigned to the marking 19. Several other markings 19 of this kind and/or indicators assigned to them can naturally also be provided for the indication of the upper and lower limits.

The measuring tube 15 is open at the top for the outflow of the protective gas. To prevent foreign particles from falling into the measuring tube 15, the upper opening is covered.

For the removal of heavy contaminations from the welding torch 2, a cleaning pot 20 is also arranged on the mounting plate 1 near the receiving cup 6. Elongated, upright brushes which rotate via a motor 22 around the longitudinal axis of the cleaning pot 20 are advantageously arranged in the cleaning pot 20. The welding torch 2 is then first, with optional robotic control, inserted into the cleaning pot 20 before insertion into the receiving cup 6.

The illustrated arrangement for measuring the quantity of protective gas forms an equipment unit which can be arranged in the working area of a robotic arm.

### REFERENCE SIGNS LIST

1 Mounting plate
2 Welding torch
3 Gas nozzle
4 Sealing ring
5 Opening in the sealing ring
6 Receiving cup
7 Ring nut
8 Spiral spring
9 Bottom rim of the receiving cup
10 Nut
11 Distance sensor
12 Reservoir
13 Drain screw
14 Outlet for the flow meter
15 Measuring tube
16 Flexible cable
17 Scale
18 Ball
19 Marking
20 Cleaning pot
21 Brushes
22 Motor

What is claimed is:

1. An arrangement for measuring the quantity of protective gas for robot-controlled importable welding torches with a protective gas nozzle in the measuring arrangement, characterized in that the measuring arrangement comprises a spring-mounted receiving cup in the direction of the insertion of the welding torch, with a sealing ring surrounding the welding torch on its outer circumference.

2. The arrangement for measuring the quantity of protective gas according to claim 1, wherein the spring deflection of the receiving cup is configurable.

3. The arrangement for measuring the quantity of protective gas according to claim 1, wherein the spring deflection of the receiving cup can be observed.

4. The arrangement for measuring the quantity of protective gas according to claim 1, wherein at least one distance sensor is assigned to the spring deflection of the receiving cup.

5. The arrangement for measuring the quantity of protective gas according to claim 1, wherein a pressure sensor with overload protection is assigned to the springs.

6. The arrangement for measuring the quantity of protective gas according to claim 1, wherein the sealing ring is interchangeably kept in the insertion opening of the receiving cup.

7. The arrangement for measuring the quantity of protective gas according to claim 1, wherein the sealing ring is made from a temperature-resistant, flexible material.

8. The arrangement for measuring the quantity of protective gas according to claim 1, wherein the opening of the sealing ring receiving the welding torch is adapted to the outer shape of the welding torch.

9. The arrangement for measuring the quantity of protective gas according to claim 1, wherein an output is located on the receiving cup for the connection of a measuring tube indicating the flowing quantity of protective gas.

10. The arrangement for measuring the quantity of protective gas according to claim 1, wherein a reservoir for capturing dirt particles is arranged below the output for the connection of the flow meter.

11. The arrangement for measuring the quantity of protective gas according to claim 1, wherein a separate cleaning pot with surrounding vertical brushes is assigned to the receiving cup for the cleaning of the outer mantel of the welding torch.
